(19) United States
(12) Patent Application Publication
(10) Pub. No.: US 2013/0346241 A1
(43) Pub. Date: Dec. 26, 2013

(54) INFRASTRUCTURE SUPPORTING A DISTRIBUTED APPROVAL WORKFLOW

(71) Applicants: Daniel J. Driscoll, Bellevue, WA (US); Nataly Pogrebinsky, Sammamish, WA (US); Jamie Yu, Redmond, WA (US); Adrian Maziak, Seattle, WA (US); Herman Man, Issaquah, WA (US)

(72) Inventors: Daniel J. Driscoll, Bellevue, WA (US); Nataly Pogrebinsky, Sammamish, WA (US); Jamie Yu, Redmond, WA (US); Adrian Maziak, Seattle, WA (US); Herman Man, Issaquah, WA (US)

(73) Assignee: Microsoft Corporation, Redmond, WA (US)

(21) Appl. No.: 13/530,129

(22) Filed: Jun. 22, 2012

(51) Int. Cl. G06Q 30/06

(52) U.S. Cl. 705/26.35

(57) ABSTRACT

The validation of a product for placement in a catalog in a marketplace utilizes a distributed approval workflow. A validation engine receives product submissions for inclusion into the marketplace's catalog. The validation engine initiates the distributed approval workflow to one or more approval engines that are equipped to perform the tasks needed to validate the product. The validation engine monitors the distributed approval workflow performed by the approval engines until completion. Upon successful completion of the distributed approval workflow, the product may be placed onto the marketplace's catalog for distribution.

### BACKGROUND

An e-commerce marketplace provides a central point of distribution for a vendor to sell goods and services and for consumers to purchase the goods and services. The marketplace often has a catalog of products for distribution to consumers. The marketplace is beneficial to vendors who may not have the means to distribute their products independently. A vendor may submit a product to the marketplace for distribution through the marketplace. Prior to the marketplace listing the vendor's product, the marketplace may validate the product and/or the vendor to ensure that the product is reliable, performs satisfactorily, and meets certain requirements. However, the process of validating different types of products from a central point of sale may be a technical challenge when the validation process consumes significant time and expense.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An e-commerce system utilizes several marketplaces to advertise and distribute products. Each marketplace has a catalog listing the products offered for distribution by the marketplace. Each marketplace may receive products from vendors to list onto the marketplace's catalog. The products submitted from the vendors are validated prior to being listed in a marketplace's catalog.

A marketplace receives the product submissions and may utilize a validation engine to formulate a distributed approval workflow to validate a product. The distributed approval workflow may be performed by several distinct approval engines that may execute in one or more servers. Each approval engine executes a specific task. The distributed approval workflow validates that the product performs as advertised in a reliable and intended manner. The validation engine monitors the progression of each approval engine involved in the distributed approval workflow until completion.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary e-commerce system utilizing one or more marketplaces.

FIG. 2 illustrates an exemplary distributed approval workflow.

FIG. 3 is a block diagram illustrating a first embodiment of an exemplary marketplace.

FIG. 4 is a block diagram illustrating a second embodiment of an exemplary marketplace.

FIG. 5 is a flow diagram illustrating the distributed approval workflow process.

FIG. 6 is a flow diagram illustrating a first exemplary method of the validation engine.

FIG. 7 is a flow diagram illustrating a second exemplary method of the validation engine.

FIG. 8 is a flow diagram illustrating an exemplary method of an approval engine.

FIG. 9 is a block diagram illustrating an operating environment.

FIG. 10 is a block diagram illustrating a first embodiment of an exemplary submission validation server.

FIG. 11 is a block diagram illustrating a second embodiment of an exemplary submission validation server.

FIG. 12 is a block diagram illustrating an exemplary approval server.

### DETAILED DESCRIPTION

Various embodiments pertain to an infrastructure supporting a distributed approval workflow. The distributed approval workflow may be used to validate products and/or content associated therewith. In one or more embodiments, once the products are validated, the products may be distributed in an e-commerce system that may include several marketplaces. Each marketplace may be configured to distribute a particular type of product.

The marketplace includes a validation engine that receives product submissions and which initiates and monitors a validation process. The validation process may differ for different types of products. The validation process is distributed into a distributed approval workflow that may be performed by one or more approval engines. The distributed approval workflow includes one or more approval workflows that may be performed to validate that the product conforms in accordance to a prescribed specification.

The validation engine manages the approval workflows performed by each approval engine until completion. Upon completion that did not result in a failure, the product may be placed in a marketplace's catalog. In the event the validation fails, a report may be returned to the vendor and the product is not placed in the marketplace's catalog.

In one or more embodiments, the marketplaces may be configured to distribute software applications. However, the technology described herein is not constrained to any particular type of product and may be applied to any type of digital data, such as without limitation, digital video files, digital audio files, text files, images, and any combination thereof.

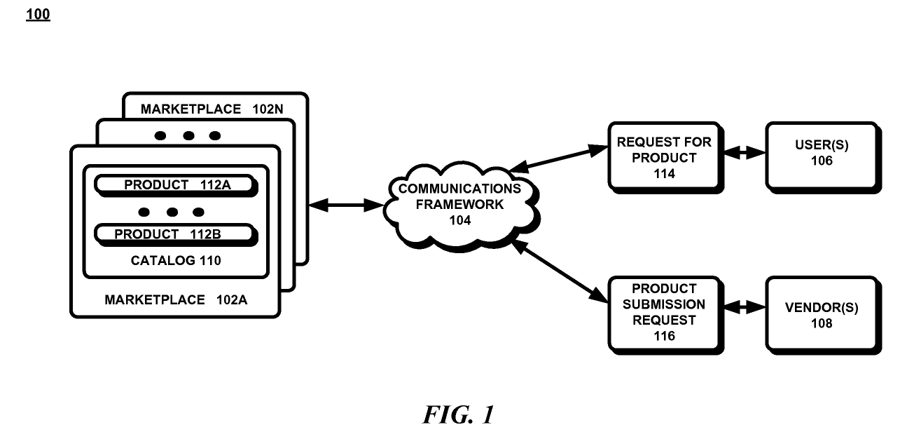

Attention now turns to a discussion of an exemplary e-commerce system. Turning to FIG. 1, the system 100 may include one or more marketplaces 102A-102N (collectively, ‘102’) that may be connected, via a communications framework 104, to one or more users 106 and one or more vendors 108. A marketplace 102 may contain a catalog 110 containing listings of one or more products 112A-112B (collectively, ‘112’). In one or more embodiments, each marketplace 102 may be configured to distribute a certain type or category of applications. For example, one marketplace may be used to distribute mobile phone applications, while another marketplace distributes video games. However, the embodiments are not constrained to a particular categorization of the product offerings and other configurations may be used for a particular implementation.

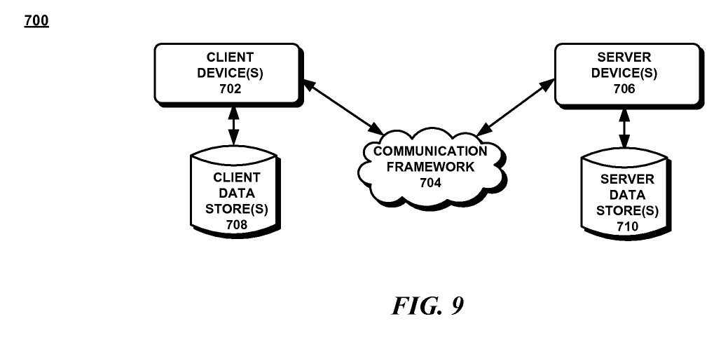

One or more users 106, through a computing device, may initiate a request for a product 114 to be distributed to a user 106. One or more vendors 108, through a computing device, may transmit a product submission request 116 to a marketplace 102 for the vendor's product to be distributed from that marketplace 102. The communications framework 104 facilitates communications between the marketplaces 102, the users 106, and the vendors 108 and is described in more detail below with respect to FIG. 9.

Although the system 100 shown in FIG. 1 has a limited number of elements in a certain configuration, it should be appreciated that the system 100 can include more or less elements in alternate configurations. The system 100 may be configured as a repository, such as a publishing system, that distributes text files, such as books, dissertations, literary works, and other such content. The system 100 may also be configured to validate products without any further distribution or retention of the product after validation. The system 100 may be configured as a single marketplace with multiple catalogs or as multiple marketplaces that share one or more catalogs. The embodiments are constrained in this manner.

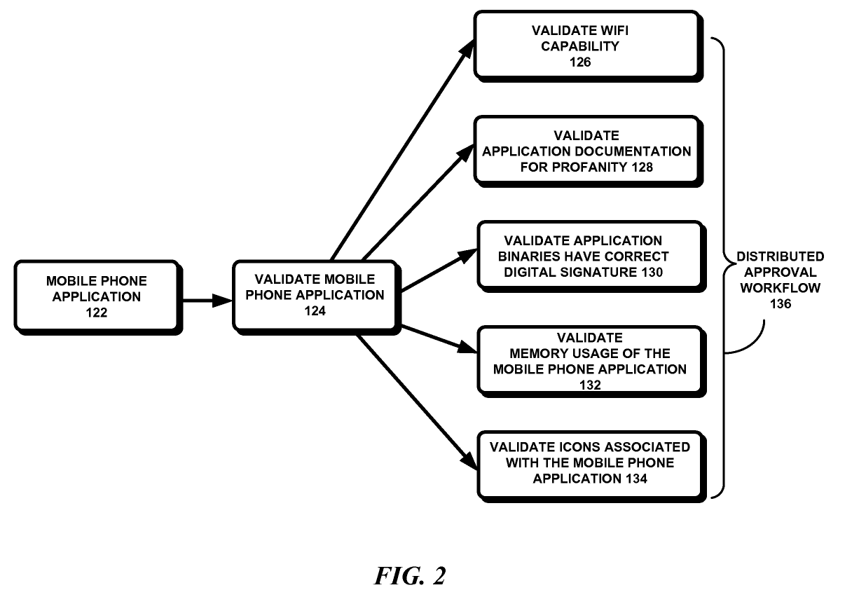

FIG. 2 illustrates an exemplary distributed approval workflow 136 for a mobile phone application 122. A marketplace 102 may validate the mobile phone application 122 (block 124) prior to listing the mobile phone application 122 in the marketplace's catalog. The validation process for the mobile phone application 122 may consist of a distributed approval workflow 136 that may include five approval workflows that include the following: (1) validate the WiFi capability of the mobile phone application (block 126); validate the mobile phone application's documentation for profanity (block 128); validate that the mobile phone application's binaries have the correct digital signature (block 130); validate that the amount of memory that the mobile phone application uses during execution is within predefined limits (block 132); and validate that the icons used to market the mobile phone application in the marketplace's catalog adhere to the marketplace's requirements (block 134).

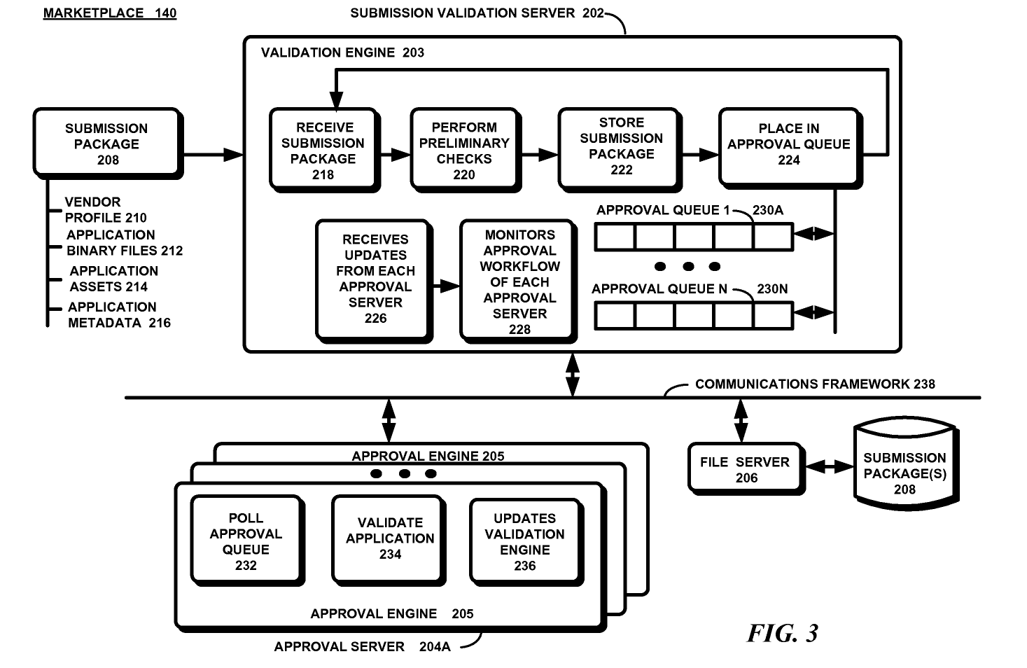

FIG. 3 illustrates a first embodiment of an exemplary configuration of a marketplace 140. A marketplace 140 may be composed of several computing devices. In one or more embodiments, a marketplace 140 may be composed of several servers, such as a cluster of submission validation servers (shown as ‘202’), one or more approval servers 204A-204N (collectively, ‘204’), and/or a file server 206. The submission validation server 202 may include a validation engine 203 that may receive product submission requests 116 from one or more vendors 108. A product submission request 116 may take the form of a submission package 208. The validation engine 203 may distribute the workflow for validating the submission package 208 to one or more approval servers 204, each having a respective approval engine 205. The validation engine 203 then monitors the approval workflows performed by the approval engine 205 until completion.

An approval engine 205 may validate an application for compliance with certain prescribed specifications, validate that the application performs as advertised, validate that the application does not interfere with other components, validate that the application executes reliably, and so forth, all considered herein as validating the application for conformance with a prescribed specification. The file server 206 may be used to store the submission packages 208 so that the contents of the submission packages 208 may be accessed by the various servers.

In one or more embodiments, a product submission request 116 may take the form of a submission package 208 that may contain a vendor profile 210, one or more application binary files 212, application assets 214, and/or application metadata 216. The vendor profile 210 may include information about the vendor, such as name, address, type of business, and so forth. The application binary files 212 include the application's executable instructions. The application assets 214 may include icons, web pages, screenshots, logos, documents, and other types of data that may be used to advertise an application in a marketplace 102. The application metadata 216 may include the application title, description, listing of hardware and/or software components needed to run the application, and so forth. It should be noted that the embodiments are not constrained to this particular configuration of a submission package 208 and that a submission package 208 may have more or less contents than what is shown in FIG. 3.

The submission validation server 202 may include a validation engine 203 and one or more approval queues 230A-230N (collectively, ‘230’). The validation engine 203 receives a submission package 208 (block 218) and may perform some preliminary checks on the contents of the submission package 208 (block 220). For example, the validation engine 203 may perform a virus scan to detect malware, check that the submission package 208 contains all the contents needed to comply with the submission requirements, check that the contents of the submission package 208 does not contain any offensive material, and so forth.

When the contents of the submission package 208 passes the preliminary checks, the submission package 208 may be stored (block 222). In one or more embodiments, a file server 206 may be utilized to store the submission package 208 in a storage location that may be accessible by the various components within the marketplace 102. In addition, the validation engine 203 may store metadata associated with the submission package 208 into an approval queue 230 (block 224).

The validation engine 203 may utilize one or more approval queues 230 to distribute the distributed approval workflow to one or more approval servers 204. In one or more embodiments, there may be an association between a particular approval queue and a particular approval server 204. For example, the approval servers 204 may be categorized by application types. Examples of application types may be mobile phone applications, video game applications, device drivers, email applications, and so forth. There may be a dedicated approval server 204 associated with validating mobile phone applications, a dedicated approval server 204 associated with validating video game applications, a dedicated approval server 204 associated with validating device drivers that run with a particular operating system, and so forth. In other embodiments, the approval servers 204 may not be specific to a particular type of application. The validation engine 203 may utilize any one of the approval servers 204 to validate an application in accordance with a load balancing policy or other policy.

An entry in an approval queue 230 contains metadata associated with a particular submission package 208. The metadata may include the location of the submission package, additional hardware or software resources needed to execute the application (e.g., GPS device, accelerometer, etc.), and so forth. An approval engine 205 polls a corresponding approval queue 230 for a submission package 208 (block 232). Alternatively, the validation engine 203 may push the approval request to the approval engine 205 (block 232). The approval engine 205 then performs the needed validation for the application (block 234). The approval engine 205 interacts with the validation engine 203 by providing the validation engine 203 updates on the status of the validation process (block 236).

The validation may result in success, failure, or interruption. A successful validation allows the application to be listed in a catalog in the marketplace 140. A failed validation may result in an error response returned to the vendor indicating the reasons why the submission may not be listed in the marketplace 140. In some instances, the validation engine 203 may interrupt and halt the approval workflow being performed by an approval engine 205. Such an interruption may occur when an updated version of the application is received after the approval workflow has commenced on a prior version.

The submission validation server 202, the approval servers 204, and the file server 206 may be connected through a communications framework 238, such as a network, bus, channel, and so forth, which may be operated in accordance with any communications protocol. The communications framework 238 facilitates communications between the different servers in the marketplace 140. In one or more embodiments, the submission validation server 202 and the approval servers 204 may be operated by the same entity (e.g., company, group, etc.). In other embodiments, the submission validation server 202 may be operated by one entity and one or more approval servers 204 may be operated by a different entity than the submission validation server 202.

Although the marketplace 140 as shown in FIG. 3 has a limited number of elements in a certain configuration, it may be appreciated that the marketplace 140 may include more or less elements in alternate topologies as desired for a given implementation. For example, multiple approval engines 205 may be grouped together onto a single approval server 204.

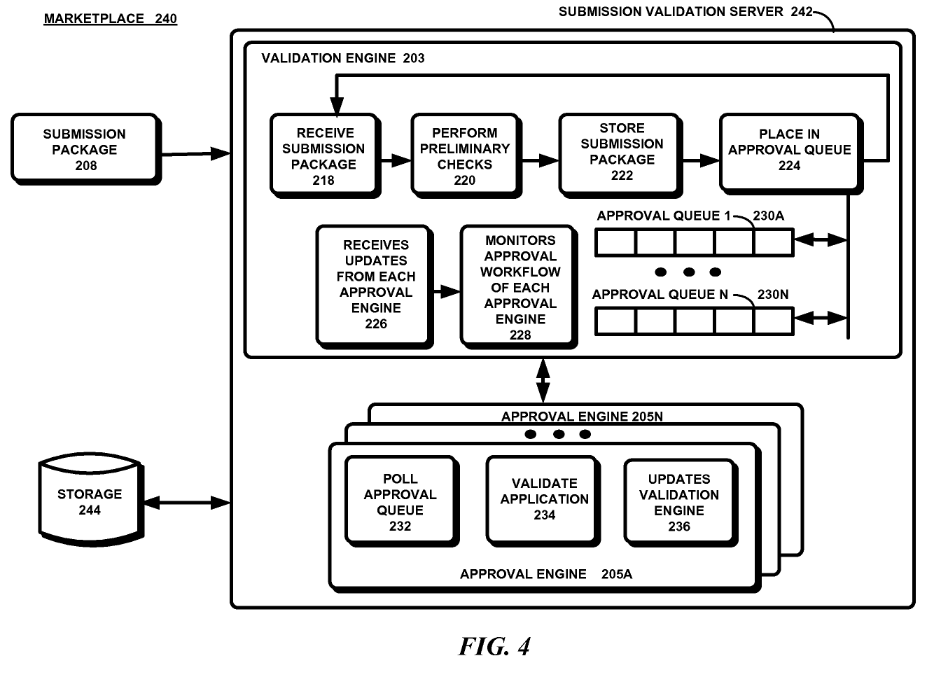

FIG. 4 illustrates a second embodiment of a marketplace 240. Although the marketplace 240 as shown in FIG. 4 has a limited number of elements in a certain configuration, it may be appreciated that the marketplace 240 may include more or less elements in alternate topologies as desired for a given implementation.

In the second embodiment, a submission validation server 242 includes the validation engine 203, the approval engines 205, and the approval queues 230. The validation engine 203 receives a submission package 208 (block 218) and may perform some preliminary checks on the contents of the submission package 208 (block 220).

When the contents of the submission package 208 passes the preliminary checks, the submission package 208 may be stored in a storage unit 244 (block 222). An entry for the submission package 208 may be placed in an approval queue 230 (block 224). The approval engine 205 may poll a corresponding approval queue 230 for a submission package 208 (block 232). Alternatively, the validation engine 203 may push the approval request to the approval engine 205 (block 232). The approval engine 205 then performs the needed validation for the application (block 234). The approval engine 205 interacts with the validation engine 203 by providing the validation engine 203 updates on the status of the validation process (block 236).

Attention now turns to operations for the embodiments which may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

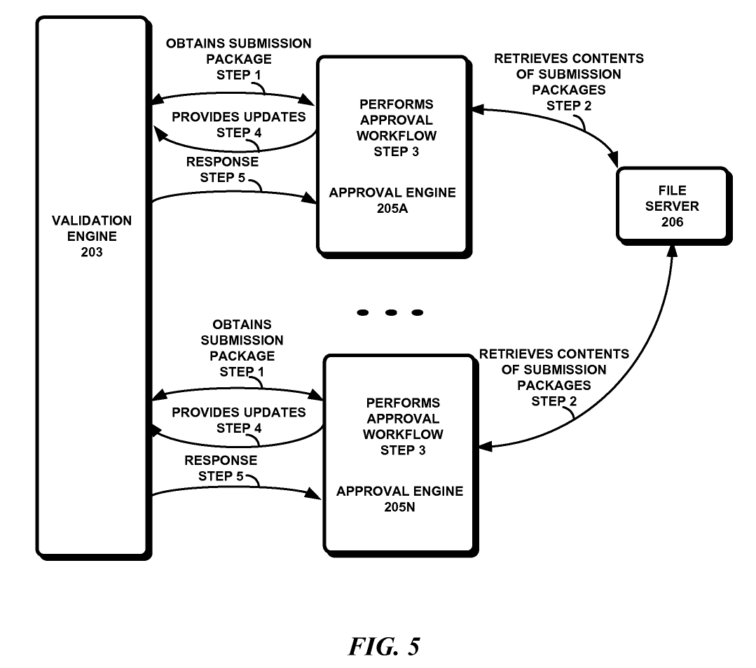

FIG. 5 illustrates the flow of the distributed approval workflow process. As shown in FIG. 5, the validation engine 203 may initiate and monitor the validation of several submission packages 208 concurrently by distributing each distributed approval workflow to multiple approval engines 205A-205N.

The validation engine 203 may utilize one or more approval queues 230 to notify a specific approval engine 205 of a submission package 208 requiring validation. There may be one or more approval queues 230 associated with a particular approval engine 205. For example, a mobile phone application may need to be validated with respect to certain cellular radio technical specifications in addition to certain operating system technical specifications. The validation for this application may require validation by two separate approval engines 205. There may be a first approval workflow executed by one approval engine 205 that validates the application with respect to cellular radio requirements and a second approval workflow executed by a second approval engine 205 that validates the application with respect to certain operating system requirements. The application is validated upon successful completion of both approval workflows.

Each approval engine 205 may obtain a submission package 208 that needs to be validated by that approval engine 205 (Obtains Submission Package Step 1). The approval engine 205 may retrieve the contents of the submission package from the file server 206 using metadata from the validation engine 203 (Retrieves Contents of Submission Packages Step 2). The approval engine 205 performs the approval workflow during which time the approval engine 205 provides updates to the validation engine 203 (Performs Approval Workflow Step 3). The updates may include data pertaining to the current state of the approval workflow processing, such as, an estimated time of completion of the approval workflow, errors occurring during execution of the approval workflow, and so forth (Provides Updates Step 4).

The validation engine 203 sends a response that replies to the update (Response Step 5). The response may include an alteration to the estimated completion time or a confirmation of the estimated completion time. The updates are provided by the approval engine 205 to the validation engine 203 at periodic intervals and the validation engine 203 keeps track of them and responds accordingly. A last update may include the outcome of the approval workflow which may be success or failure.

In one or more embodiments, the validation engine 203 may be implemented as a process that may utilize one or more independent threads of execution to perform a subset of the validation engine's tasks. For example, the validation engine 203 may utilize one thread to receive submission requests from users, and another thread to receive the updates from the approval engines. Likewise, each approval engine 205 may utilize one or more independent threads of execution to perform the approval engine's tasks. For example, an approval engine 205 may utilize one thread to execute the approval workflow and another thread to provide the updates to the validation engine 203. However, the embodiments are not constrained to any particular implementation of the validation engine 203 and the approval engines 205. The validation engine 203 and the approval engines 205 may be executed in a serial manner or executed in parallel. The embodiments are not constrained in this manner.

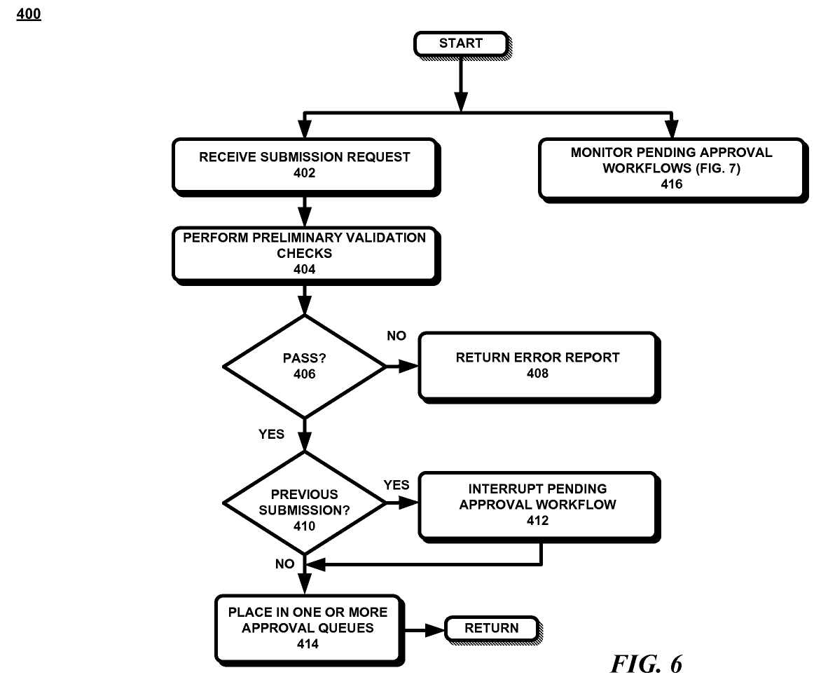

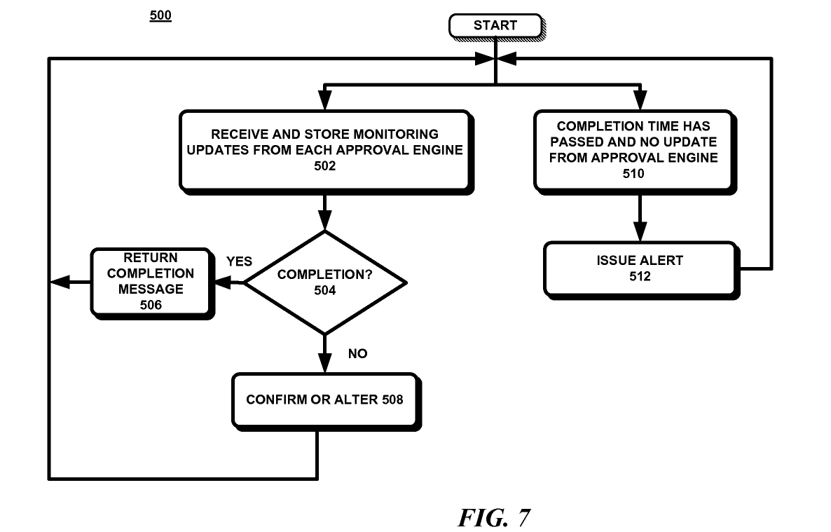

FIGS. 6-7 are flow diagrams illustrating an exemplary method of the validation engine 203. It should be noted that the method may be representative of some or all of the operations executed by one or more embodiments described herein and that the method can include more or less operations than that which is described in FIGS. 6-7.

The validation engine 203 may create one or more threads that process submission requests (block 402) and one or more threads that monitor pending approval workflows (block 416). In this manner, the validation engine 203 may process multiple approval workflows concurrently.

The validation engine 203 may perform some preliminary validation checks on the submission package (block 404). If the preliminary validation checks fail (block 406—no), then the validation engine 203 may return an error report back to the vendor indicating the errors (block 408).

In the event a submission package is for a product that is currently being approved (block 410—yes), the validation engine 203 may interrupt the pending approval workflow and initiate processing for the current submission (block 412). If the submission package is not related to a previous submission (block 410—no), the submission package is stored in the file server and metadata associated with the submission package is placed into an appropriate approval queue (block 414).

Referring to FIG. 7, the validation engine 203 receives updates from each approval engine 205 that is stored by the validation engine 203 for later use (block 502). An update may include a completion status, an estimated time of completion, and/or messages that may be returned to the vendor. If the update indicates that the approval workflow has completed (block 504—yes), then a completion message may be returned to the vendor and the product may be listed in the catalog of a marketplace 102 (block 506).

Otherwise, if the update is not a completion status (block 504—no), then the update may indicate an estimated time of completion and status (block 508). The validation engine 203 may confirm the estimated time of completion by transmitting a completion message to the approval engine 205 (block 508). The validation engine 203 may also alter the estimated time of completion which the validation engine 203 transmits to the approval engine 205 (block 508).

The validation engine 203 keeps track of the estimated time of completion of each approval workflow. In the event the completion time has lapsed and the validation engine 203 has not received an update from an approval engine 205, the validation engine 203 may issue an alert (block 512). The alert is used to indicate a problem with the approval engine 205. For example, the approval engine 205 may be offline or has encountered a failure that prevents the approval engine 205 from completing the approval workflow.

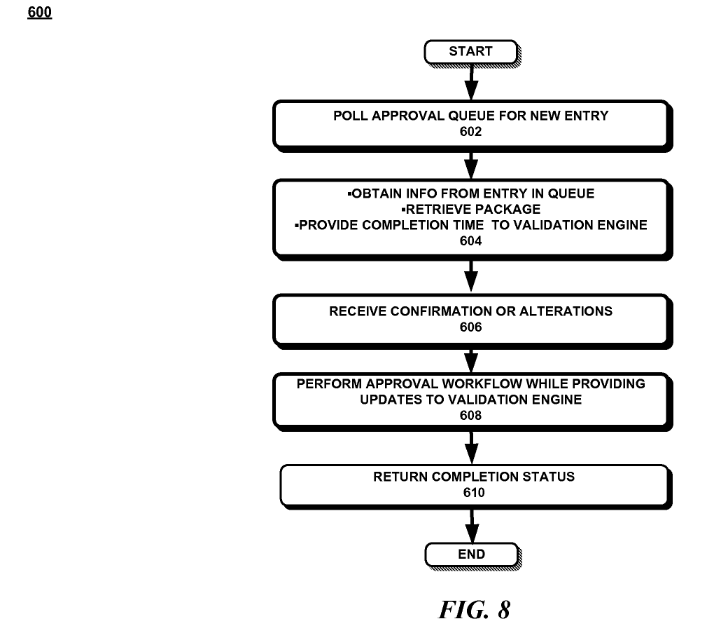

FIG. 8 illustrates a flow diagram of an exemplary method 600 of an approval engine 205. It should be noted that the method may be representative of some or all of the operations executed by one or more embodiments described herein and that the method can include more or less operations than that which is described in FIG. 8.

An approval engine 205 may be configured to execute the approval workflows that are associated with certain types of applications. The approval engine 205 may be equipped with special resources needed to perform the approval workflow for a particular category of applications that may not be available to other approval engine 205. The approval workflows are a sequence of tasks that may be implemented as a sequence of executable instructions.

An approval engine 205 may poll the validation engine 203 for an entry in the approval queue 230 associated with the approval engine 205 (block 602). The entry in the approval queue 230 may include metadata that indicates a location of the submission package 208, special resources needed to execute the approval workflow, and so forth (block 604). The approval engine 205 may utilize the metadata to obtain certain contents of the submission package 208 (block 604). The approval engine 205 may analyze the contents of the submission package 208 and provide the validation engine 203 with a transmission message indicating, at least, an estimated time of completion for the approval workflow (block 604).

The approval engine 205 may receive a confirmation from the validation engine 203 either confirming the estimated time of completion, or altering the estimated time of completion to a new time (block 606). The validation engine 203 may also inform the approval engine 205 that the approval engine 205 does not have to report back, allow the approval engine 205 assume the completion time, or cancel the approval process (block 606). The approval engine 205 may then execute the approval workflow while periodically submitting updates to the validation engine 203 (block 608). The approval engine 205 may execute the approval workflow to completion and the completion status is returned to the validation engine 203 (block 610). The completion status may indicate that the approval workflow performed successfully and may include messages and non-critical warnings thereby validating the product for distribution in the marketplace. The completion status may also indicate that the approval workflow performed unsuccessfully encountering an error or failure that may be reported back to the validation engine 203.

Attention now turns to a discussion of an exemplary operating environment. FIG. 9 illustrates an operating environment 700. It should be noted that the operating environment 700 is exemplary and is not intended to suggest any limitation as to the functionality of the embodiments. The embodiment may be applied to an operating environment 700 having one or more client device(s) 702 in communication through a communications framework 704 with one or more server device(s) 706. Each user 106 and vendor 108 may utilize a client device 702. The marketplace may be implemented as a service that utilizes one or more server devices 706.

A client device 702 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A client device 702 may also be embodied as a software module having instructions that execute in a single execution path, multiple concurrent execution paths (e.g., thread, process, etc.), or in any other manner

A server device 706 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A server device 706 may also be embodied as a software module having instructions that execute in a single execution path, multiple concurrent execution paths (e.g., thread, process, etc.), or in any other manner.

The communications framework 704 facilitates communications between the client devices 702 and the server devices 706. The communications framework 704 may embody any well-known communication techniques, such as techniques suitable for use with packet-switched networks (e.g., public networks such as the Internet, private networks such as enterprise intranet, and so forth), circuit-switched networks (e.g., the public switched telephone network), or a combination of packet-switched networks and circuit-switched networks (with suitable gateways and translators). A client device 702 and a server device 706 may include various types of standard communication elements designed to be interoperable with the communications framework 704, such as one or more communications interfaces, network interfaces, network interface cards, radios, wireless transmitters/receivers, wired and/or wireless communication media, physical connectors, and so forth. Examples of wired communications media may include a wire, cable, metal leads, printed circuit boards, backplanes, switch fabrics, semiconductor material, twisted-pair wire, coaxial cable, fiber optics, a propagated signal, and so forth. Examples of wireless communications media may include acoustic, radio frequency spectrum, infrared, and other wireless media.

Each client device 702 may be coupled to one or more client data store(s) 708 that store information local to the client device 702. Each server device 706 may be coupled to one or more server data store(s) 710 that store information local to the server device 706.

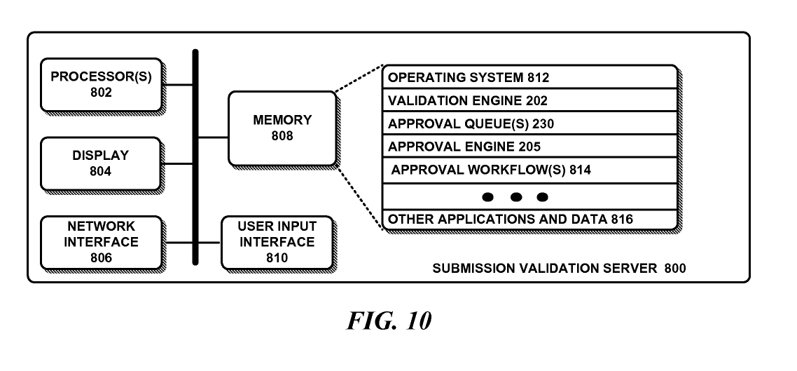

FIG. 10 illustrates a block diagram of a first embodiment of an exemplary submission validation server 800 in the marketplace configuration where the approval engines and the validation engine are executed in the submission validation server 800. The submission validation server 800 may have one or more processors 802, a display 804, a network interface 806, a memory 808, and/or a user input interface 810. The processors 802 may be any commercially available processor and may include dual microprocessors and multi-processor architectures. The display 804 may be any visual display unit. The network interface 806 facilitates wired or wireless communications between the submission validation server 202 and a communications framework. The user input interface 810 facilitates communications between the submission validation server 800 and input devices, such as a keyboard, mouse, etc.

The memory 808 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 808 may also include one or more external storage devices or remotely located storage devices. The memory 808 may contain instructions and data as follows:
an operating system 812;
a validation engine 202;
one or more approval queues 230;
an approval engine 205;
one or more approval workflows 814; and
various other applications and data 816.

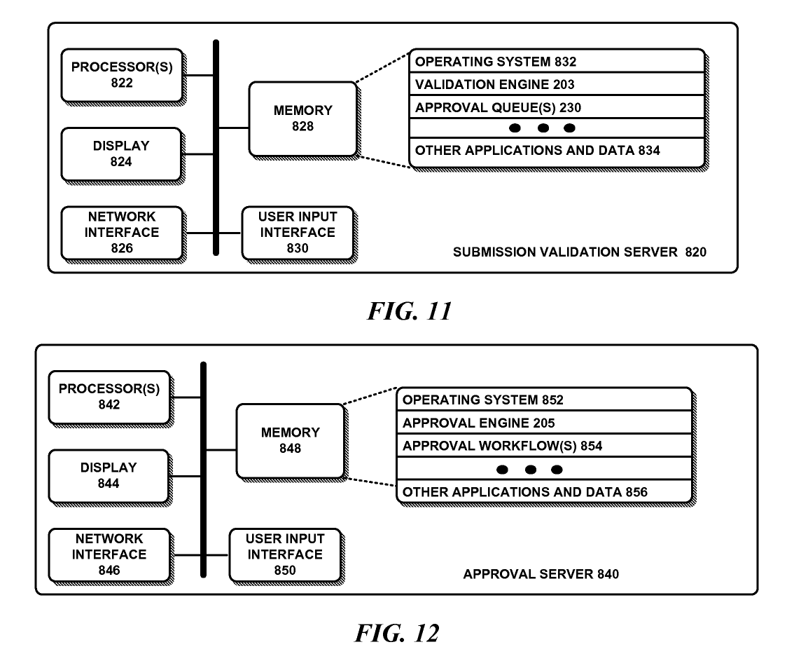

FIG. 11 illustrates a block diagram of a second embodiment of an exemplary submission validation server 820 in the marketplace configuration where the approval engines 205 and the validation engine 203 are executed in different servers. The submission validation server 820 may have one or more processors 822, a display 824, a network interface 826, a memory 828, and/or a user input interface 830. The processors 822 may be any commercially available processor and may include dual microprocessors and multi-processor architectures. The display 824 may be any visual display unit. The network interface 826 facilitates wired or wireless communications between the submission validation server 820 and a communications framework. The user input interface 830 facilitates communications between the submission validation server 820 and input devices, such as a keyboard, mouse, etc.

The memory 828 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 828 may also include one or more external storage devices or remotely located storage devices. The memory 828 may contain instructions and data as follows:
an operating system 832;
a validation engine 203;
one or more approval queues 230; and
various other applications and data 834.

FIG. 12 illustrates a block diagram of an exemplary approval server 840. An approval server 840 may have one or more processors 842, a display 844, a network interface 846, a memory 848, and/or a user input interface 850. The processors 842 may be any commercially available processor and may include dual microprocessors and multi-processor architectures. The display 844 may be any visual display unit. The network interface 846 facilitates wired or wireless communications between the approval server 840 and a communications framework. The user input interface 850 facilitates communications between an approval server 840 and input devices, such as a keyboard, mouse, etc.

The memory 848 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 848 may also include one or more external storage devices or remotely located storage devices. The memory 848 may contain instructions and data as follows:
an operating system 852;
an approval engine 205;
one or more approval workflows 854; and
various other applications and data 856.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

What is claimed:

1. A computer-implemented method, comprising:
providing a catalog of products offered for distribution to users;
receiving, at an validation engine, a submission request to include a first product in the catalog;
initiating, from the validation engine, a first approval workflow to at least a first approval engine, the first approval engine different from the validation engine, the first approval workflow having one or more tasks that validate the product in conformance with a first prescribed specification;
receiving, at the validation engine, a completion status; and
upon receipt of a successful completion status, listing the product in the catalog.

2. The computer-implemented method of claim 1, further comprising:
receiving from the first approval engine an estimated time of completion for the first approval workflow.

3. The computer-implemented method of claim 2, further comprising:
issuing, from the validation engine, a confirmation to the first approval engine for the estimated time of completion for the first approval workflow.

4. The computer-implemented method of claim 2, further comprising:
issuing, to the first approval engine, an altered time for the estimated time of completion for the first approval workflow.

5. The computer-implemented method of claim 2, further comprising:
monitoring the first approval engine for completion of the first approval workflow after the estimated time of completion has lapsed.

6. The computer-implemented method of claim 5, further comprising:
issuing an alert when the first approval engine does not respond at the estimated time of completion.

7. The computer-implemented method of claim 1, further comprising:
distributing, from the validation engine, a second approval workflow for the product to a second approval engine, the second approval workflow executing one or more tasks that validate the product in conformance with a second prescribed specification.

8. The computer-implemented method of claim 7, further comprising:
waiting for a successful completion status from the second approval engine before listing the product in the catalog.

9. A computer-readable storage medium storing thereon processor-executable instructions for validating a product, comprising:
at least one approval engine, having instructions that when executed on a processor
initiates an approval workflow to perform a validation for the product, the approval workflow containing one or more tasks that validate the product for conformance with a prescribed specification,
updates a validation engine of an estimated completion time for the approval workflow,
performs the approval workflow, and
updates the validation engine with a status of an outcome of completion of the approval workflow.

10. The computer-readable storage medium of claim 9, the approval engine having further instructions that when executed on a processor, transmits back to the validation engine an update for the estimated completion time of the validation.

11. The computer-readable storage medium of claim 9, the approval engine, having further instructions that when executed on a processor, interrupts processing of the approval workflow due to receipt of an interrupt directive from the validation engine.

12. The computer-readable storage medium of claim 9, the approval engine, having further instructions that when executed on a processor, receives a confirmation of the estimated completion time from the validation engine.

13. The computer-readable storage medium of claim 9, the approval engine, having further instructions that when executed on a processor, receives an altered completion time from the validation engine and alters the approval workflow to perform within the altered completion time.

14. The computer-readable storage medium of claim 9, the approval engine, having further instructions that when executed on a processor, retrieves the product from a file server.

15. A system, comprising:
a plurality of marketplaces, each marketplace having a catalog including a plurality of products for distribution to users of a marketplace, each marketplace having a validation engine communicatively coupled to a plurality of approval engines, the validation engine configured to receive submission packages containing a product for validation, the validation engine configured to initiate a distributed approval workflow for the product to at least one approval engine, to monitor a status of the distributed approval workflow through updates provided by each approval engine, and to validate the product for inclusion in a catalog upon a successful status of the distributed approval workflow.

16. The system of claim 15, the validation engine further configured to perform a preliminary check of the submission package prior to initiating a distributed approval workflow for the product.

17. The system of claim 15, the validation engine and the approval engines communicatively coupled to a file server, the file server storing the submission package.

18. The system of claim 15, the validation engine configured to receive updates from each approval engine and to transmit responses to each approval engine responding to the updates.

19. The system of claim 15, the validation engine configured to initiate a plurality of distributed approval workflows to multiple approval engines concurrently.

20. The system of claim 15, the validation engine configured to initiate two or more approval workflows from a distributed approval workflow for a same submission package to more than one approval engine.
